(19) United States
(12) Patent Application Publication
(10) Pub. No.: US 2015/0262100 A1
(43) Pub. Date: Sep. 17, 2015

(54) USE OF POLYGON LOADING AREAS FOR INCREASING EFFICIENCY OF FIELD DISPATCH IN A TELECOMMUNICATIONS SETTING

(71) Applicant: Verizon Patent and Licensing Inc., Arlington, VA (US)

(72) Inventors: Jesse Hefter, Brookline, MA (US); Katherine T. Ross, Chesapeake, VA (US); Pankaj Nagpal, New Brunswick, NJ (US); Gopakumar P. Pillai, Elkridge, MD (US); Venkat S. Mylavarupu, Sterling, VA (US); Scott R. Waddell, Essex, MD (US)

(73) Assignee: Verizon Patent and Licensing Inc., Arlington, VA (US)

(21) Appl. No.: 14/212,287

(22) Filed: Mar. 14, 2014

(51) Int. Cl. G06Q 10/06

(52) U.S. Cl. CPC G06Q 10/06311

(57) ABSTRACT

A dispatch system and method for a dispatch coverage region including a set of dispatch assignment areas (DAAs), wherein the shape of the DAAs are based on at least a first aspect of the dispatch coverage region, e.g. the physical wiring distribution. The system includes a geographic zone where the shape of the geographic zone is based on at least a second aspect of the dispatch coverage region different from the first aspect, e.g. special authorized access or logistical continuity. The geographic zone overlaps a DAA to define an overlapping area. The system also includes a set of technician profiles, where a first technician profile identifies a preferred geographic zone and a second technician profile identifies a preferred DAA. The system or method recommends assigning a job request that includes a location residing in the overlapping area to the first technician profile when the preferred geographic zone matches.

### BACKGROUND INFORMATION

Companies have call centers to receive requests from customers and some of these calls will generate jobs, such as to repair existing equipment, install new services or cancel services. Requests resulting in jobs may also be generated from other sources such as, for example, maintenance requirements and new building development. A dispatch center receiving such requests may assign (dispatch) the jobs to technicians who will go out to the job location and fulfill the job requests. There may be a large volume of jobs to dispatch, requiring the use of multiple dispatch centers. To aid in the assignment of technicians to the jobs, typically a geographic coverage region is broken down into more manageable geographic areas. The locations, e.g. addresses, of the job may be associated with a geographic area. The system will assign jobs to technicians, and to be efficient it is best to assign a technician several jobs in the geographic area to minimize travel time. Sometimes certain jobs will have additional requirements, like requiring a photo badge to gain access to the facility, and only certain technicians will have the additional requirement. It can be difficult for the dispatch center to determine the job requests that have an additional requirement and likewise difficult to find a technician that has the additional requirement.

### BRIEF DESCRIPTION OF THE DRAWINGS

FIG. 1 illustrates an exemplary dispatch system.

FIG. 2 illustrates a dispatch coverage region with garages.

FIG. 3 illustrates a geographic zone that crosses multiple dispatch assignment areas.

FIG. 4 illustrates an exemplary logistical geographic zone.

FIG. 5 illustrates an exemplary special access geographic zone.

FIG. 6 illustrates an exemplary two-man-area geographic zone.

FIG. 7 is an exemplary screenshot showing the creation of a geographic zone.

FIG. 8 is an exemplary screenshot showing job locations graphically in the completed geographic zone.

FIG. 9 is a flowchart of an exemplary process that creates a proposed dispatch schedule for a technician.

### DETAILED DESCRIPTION

An exemplary dispatch system includes a dispatch coverage region and may include a pre-existing topography of dispatch assignment areas (DAAs) and an ability to interactively create, using a map, an ad hoc geographic area, e.g. a polygon shape, called a geographic zone, that the dispatch system uses in precedence over the DAAs when assigning jobs. The geographic zone may delineate areas for logistical continuity or other aspects of the dispatch coverage region such as a two-person-area or sites with special access requirements. The system may define a geographic zone based on logistical continuity, for example, a contiguous walkable zone in a city where the technician does not have a vehicle, but instead walks between jobs. A geographic zone may require additional site-based security, for example, requiring all who enter have a security badge. The geographic zone may be a two-person-area where personal safety or the security of equipment and vehicles are a concern. In a two-person-area, one person may a properly trained technician to do the work and the second individual may not be a technician and may provide assistance and keep track of equipment and vehicles.

The dispatch coverage region is broken down into smaller “garage areas” that have a garage and assigned technicians where the garage may serve as a home base for the technicians. The dispatch system may develop proposed job assignments at the garage level, utilizing the group of assigned technicians, assignment steps and garage-rules about the requirements for the assignments.

A garage area is composed of a series of non-overlapping DAAs, so that for any given location one unambiguous DAA exists. With the addition of the geographic zones, a layer of priority can be established for locations within a geographic zone. Likewise, to enable a clear prioritization of assignment areas, the geographic zones should also not overlap, this way a single simple one-layer priority is available in the dispatch system. The geographic zone priority enables the dispatch system to recognize and automatically generate proposed job assignments related to aspects of the dispatch coverage region that are unrelated to the wiring aspect of the dispatch coverage region on which the DAA shapes are based.

An exemplary dispatch system may identify field technicians in the dispatch system with a profile that includes preferred geographic zones and preferred DAAs. The profile may indicate a plurality of geographic zones such as a primary geographic zone and a secondary geographic zone for which they have the proper attributes (e.g., acceptably credentialed or trained). Similarly, the profile may include a plurality of DAAs such as a primary DAA and a secondary DAA, which serve to identify those locations that are most convenient for a technician to work at, for example, because they are close to their residence. When the dispatch system receives a job, the job has an associated location, e.g. an address. If the job location is in a geographic zone, the DAA may be ignored and the dispatch system will assign the job to one of the technicians who include that geographic zone as one of their preferred geographic zones. In an alternative implementation, if the job location matches both the preferred geographic zone and the preferred DAA of a particular profile, the system may give priority to that profile for that job. If the job location is not in a geographic zone then the job may be assigned to a technician with a profile that has a preferred DAA matching the DAA that the job is located in. Within the dispatch coverage region for the dispatch system, a predefined number of discrete DAAs are likely to cover the entire dispatch coverage region, while the geographic zones may only cover a subset of the dispatch coverage region enveloping some DAAs and only partially incorporating other DAAs

On occasion technicians will be loaned from their normal garage to another garage, e.g. after a storm, for extra cable installations at the beginning of a college semester etc. The garage-rules can be set to either ignore all the loaned technician profile preferences or could expect the loaned technician to have profile preferences that include geographic zones and DAAs for this garage.

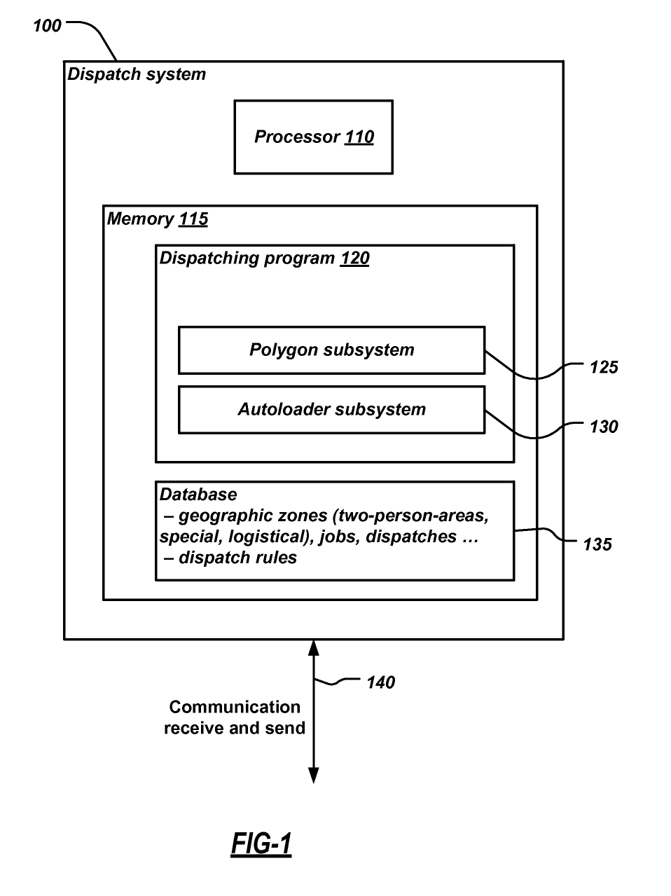

FIG. 1 illustrates an exemplary dispatch system 100 for dispatching jobs to field technicians. The dispatch system 100 may take many different forms and include multiple and/or alternate components and facilities. While the figures show an exemplary dispatch system 100, the exemplary components illustrated in the figure are not limiting, indeed, one may expect in a particular implementation additional or alternate components or configurations.

As illustrated in FIG. 1, the dispatch system 100 may include a processor 110, a memory 115, and use communication channels 140. The memory 115 may hold a dispatching subsystem 120, and database 135. The dispatching program 120 may have a polygon subsystem 125 and an autoloader subsystem 130.

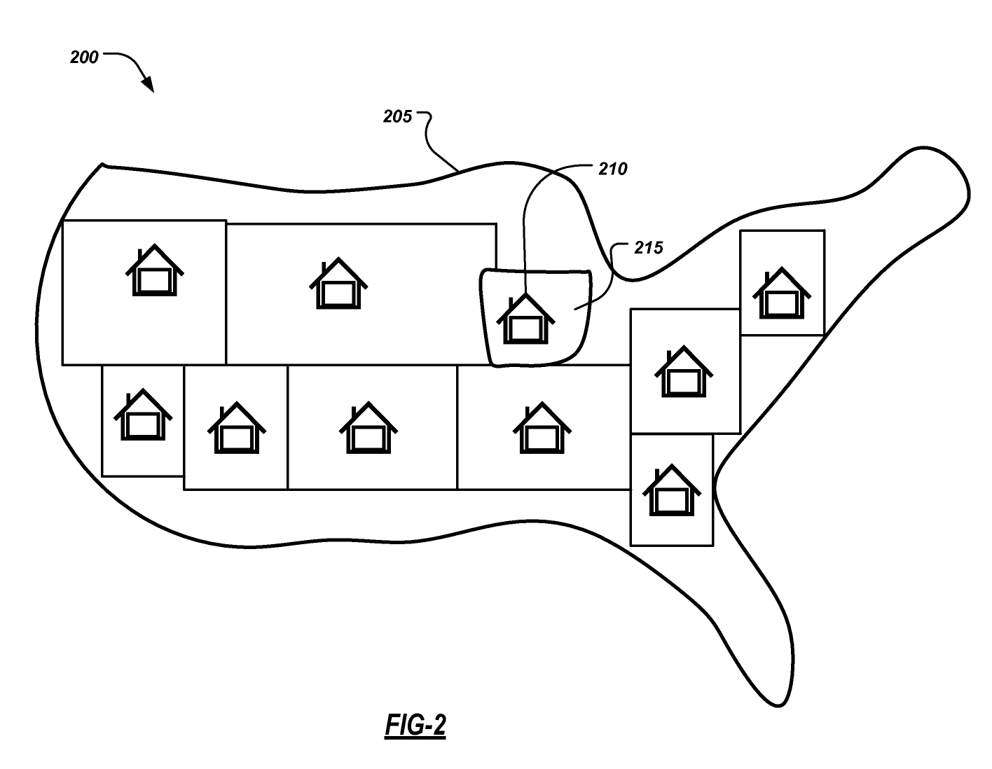

The dispatch system 100 may dispatch jobs within a dispatch coverage region. FIG. 2 illustrates a rough map 200 of a dispatch coverage region 205 with a first geographic zone 310 and a second geographic zone 350. The dispatch system 100 has the dispatch coverage area 205 has a number of the garages 210 that have an associated set of technicians that the dispatch system 100 may use to dispatch technicians from to complete the jobs in the garage coverage area 215. A garage 210 is typically a building where tools and trucks are located that has an associated group of field technicians to dispatch into the garage area 215. The system 100 may also identify a garage 210 as a work center, yard or sometimes a mobile garage.

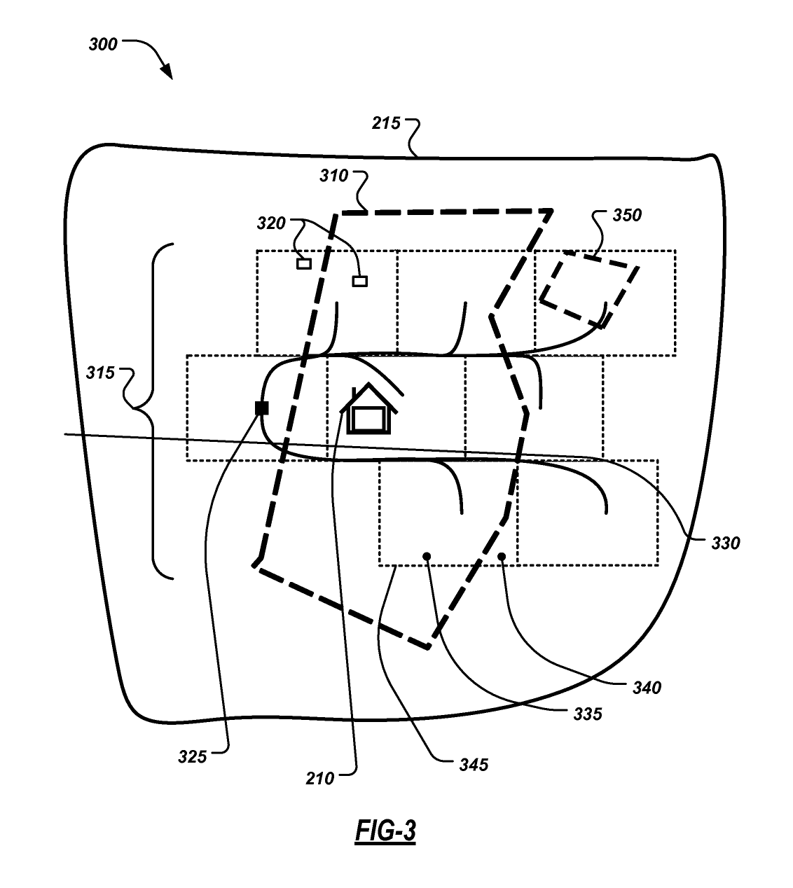

The dispatch system 100 includes geographic zones as illustrated in FIG. 3 with a rough map 300 of the garage area 215 with a geographic zone 310 that spans multiple DAAs 315 in the garage area 215. The geographic zone 310 is a geographic area that may be a polygon shape in the garage area 215, and may also be known as a polygon zone. The geographic zone 310 may be big or small relative in size to the size of DAAs 315. The geographic zone may either fit inside a DAA 315, like geographic zone 350, or span multiple DAAs 315, like geographic zone 310. A location, i.e. address, may be in a specific geographic zone 310. The geographic zone 310 may have a non-technical technician attribute associated to it, such as the technician profile having an attribute of being two-person-area capable, or requiring special access for entry.

In the illustrated example, the DAAs 315 are the rectangle shapes that cover the garage area 215 that represent geographic areas. While uniformly sized DAAs 315 are shown, they are not limited to such a size. The DAAs 315 make up a topography covering the garage area 215 where each location, e.g. address, in the dispatch coverage region 305 is associated with one and only one DAA 315. Although the figures do not clearly show it, the DAAs 315 are expected to cover the entire garage area 215 and the entire dispatch coverage area 205. DAAs 315 represent various telecommunication-oriented areas, e.g., Dispatch Assignment Areas or Central Offices (DAA/CO). DAAs 315 are geographic areas that tend to be related to cable and wiring 330 as they branch out from a Central Office 325. The cable signal is disseminated through the CO 325 (also known as a central switching office), which tends to be a nondescript building that only has stationary equipment, although some COs 325 are associated to a garage 210. For example, a main cable (e.g. a cable TV line) starts at the Central Office 325 hub and then is divided at smaller hubs into two smaller lines 330, which in turn divide into still smaller lines, until the lines terminate at the final customer location, e.g. a house or business (not shown). The locations are associated to assignment area, AA, and the assignment areas are grouped up into DAAs 315 and the DAAs are grouped into garage areas 215 and the garage areas 215 make up the dispatch coverage region 205.

The DAAs 315 are a series of non-overlapping DAAs 315 that for any given location provide one unambiguous DAA 315. The geographic zones provide the ability to have a layer of priority that can override the dispatch assignment areas (DAAs) 315 for locations within a geographic zone 310. Likewise, to enable a clear prioritization of assignment areas the geographic zones 310 should also not overlap, this way a single simple one-layer priority is available in the dispatch system. The geographic zone priority enables the dispatch system to recognize and automatically generate proposed job assignments related to aspects of the dispatch coverage region 205 that are unrelated to the wiring aspect of the dispatch coverage region 205 as represented by the set of DAA 315. Examples of aspects of the dispatch coverage region 205 are two-person-areas, areas requiring special access and logistic advantageous areas.

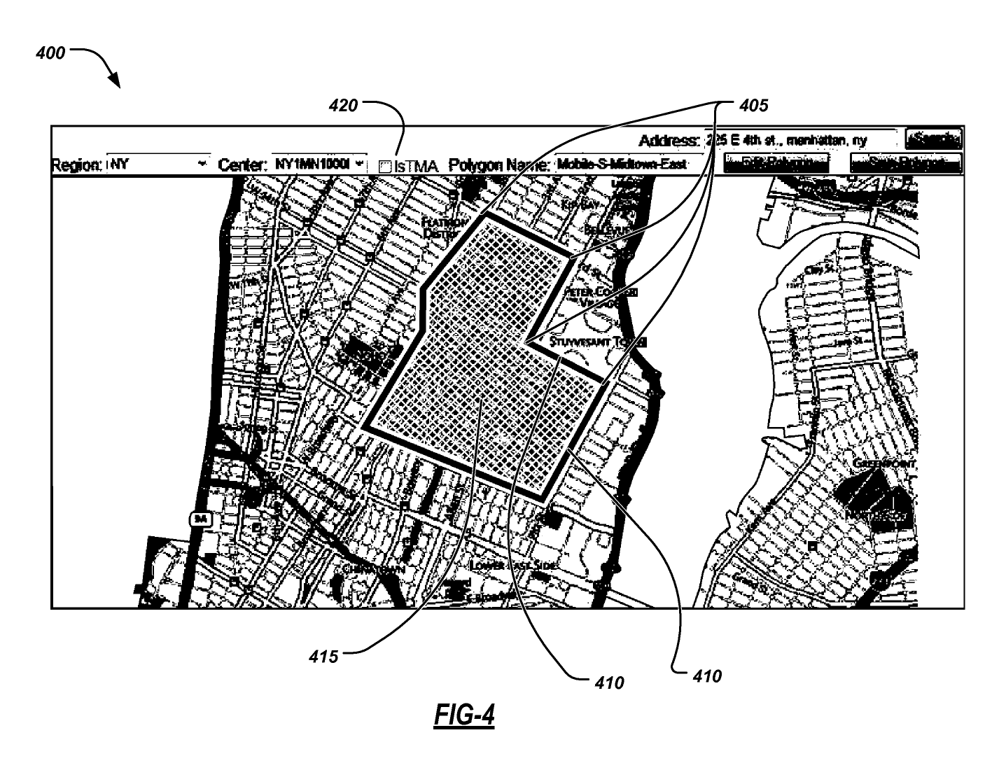

In one exemplary approach when a job 335 is inside the overlap of geographic zone 310 and DAA 345 then the dispatch system 100 will assign the job request to a technician who has the geographic zone 310 specified as a preferred geographic zone. The dispatch system 100 will not assign the job request to a technician who has DAA 345 specified as a preferred DAA 315 unless that technician also has a profile identifying the preferred geographic zone 310. Thus, when a geographic zone 310 is involved, it may override a preferred DAA 315. In an alternative implementation, when a technician profile is associated with both the geographic zone 310 and the DAA 345, that technician profile may be given special priority to be assigned the job 335. When a job 340 is outside the geographic zone 310, but inside the DAA 345 then in one exemplary approach the system 100 will assign the job to a technician profile with the DAA 345 specified as a preferred DAA 315. FIG. 4 shows a screenshot 400 of the dispatch system 100 displaying an exemplary logistical geographic zone 415 with vertices (e.g. corners 405) and edges, (e.g. lines 410). The checkbox for being a two-person-area is not checked, see “IsTMA” 420, indicating this either a logistical geographic zone or special access geographic zone; in this case it is a logistical geographic zone 415.

The exemplary dispatch system 100 enables a user to carefully customize the dispatch zones to optimize the dispatch system 100. For example, the user may optimize the logistical geographic zone 415 to minimize a field technician's travel time; by creating logistical geographic zones 415 that do not have a major highway running through them, the technician will not have to use-up time crossing a major highway. These logistical geographic zones 415 may reduce drive time and thus vehicle emissions and increase productivity, since the logistical geographic zone 415 may help reduce technicians driving between jobs, which may be particularly helpful in avoiding high-traffic areas during rush hour traffic.

Some of the logistical geographic zones 415 will be for densely populated areas where the geographic zones 310 are walking-zones that are part of a mobile-garage used in densely populated cities. The system may also know walking-zones as walking areas, mobile garage zones or mobile bus zones (because a company bus may drive the technicians to their walking-zones). The exemplary dispatch system 100 may use walking-zones in downtown cities, like New York and Boston. In a walking-zone, and the technicians do not work out of the traditional brick-and-mortar garage 210 with a vehicle, but rather operate on foot, toting their tools with them on a rolling wheeled toolbox, and possibly the company uses a “mobile garage” (e.g. a bus) to drop off technician at their logistical geographic zone 415.

The exemplary dispatching system 100 may further have a geographic zone 310 identified as requiring field technicians with additional non-technical attributes. Such non-technical attributes may include specific qualifications associated with the technician such as a specific level of training or capabilities relevant to the geographic zone, for example, being trained to work in two-person-areas or having specific security clearance.

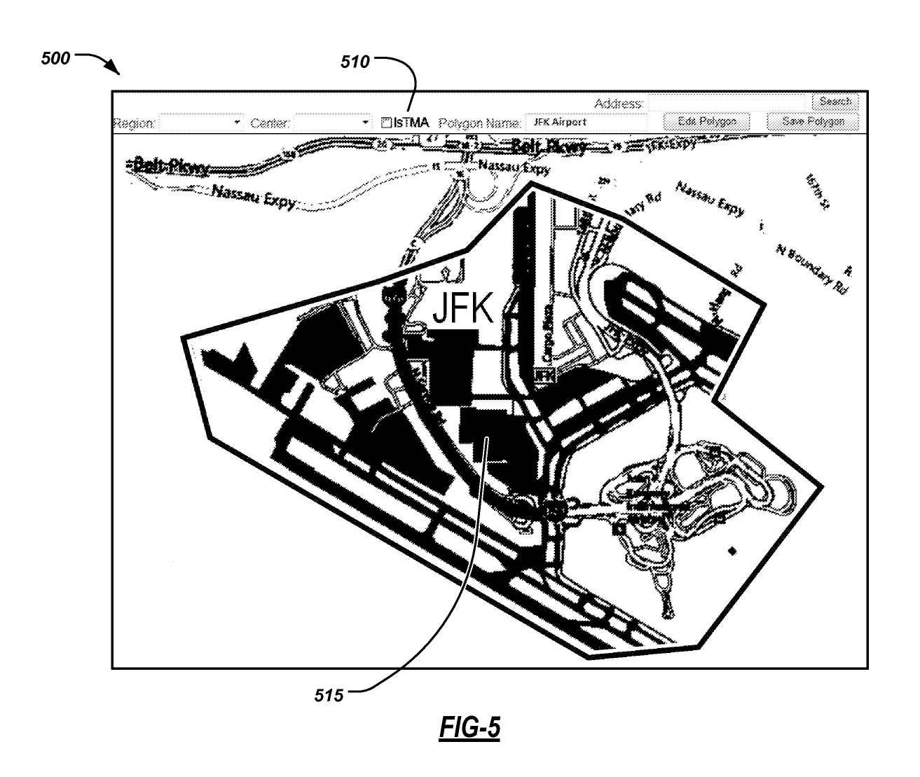

FIG. 5 is a screenshot 500 of an exemplary special access zone 515. The checkbox for being a two-person-area is not checked, see “IsTMA” 510, indicating this geographic zone is either a logistical geographic zone or special access geographic zone. In this case, the zone is a special access geographic zone 515, specifically a security zone around an airport. A special access geographic zone 515 may be specified when access to the job location is controlled, for example, defense facilities, airports, new construction areas, etc. A special access geographic zone 515 may require the technician to have an issued security badge, or be on a list to gain access to the special access geographic zone 515 to do the work.

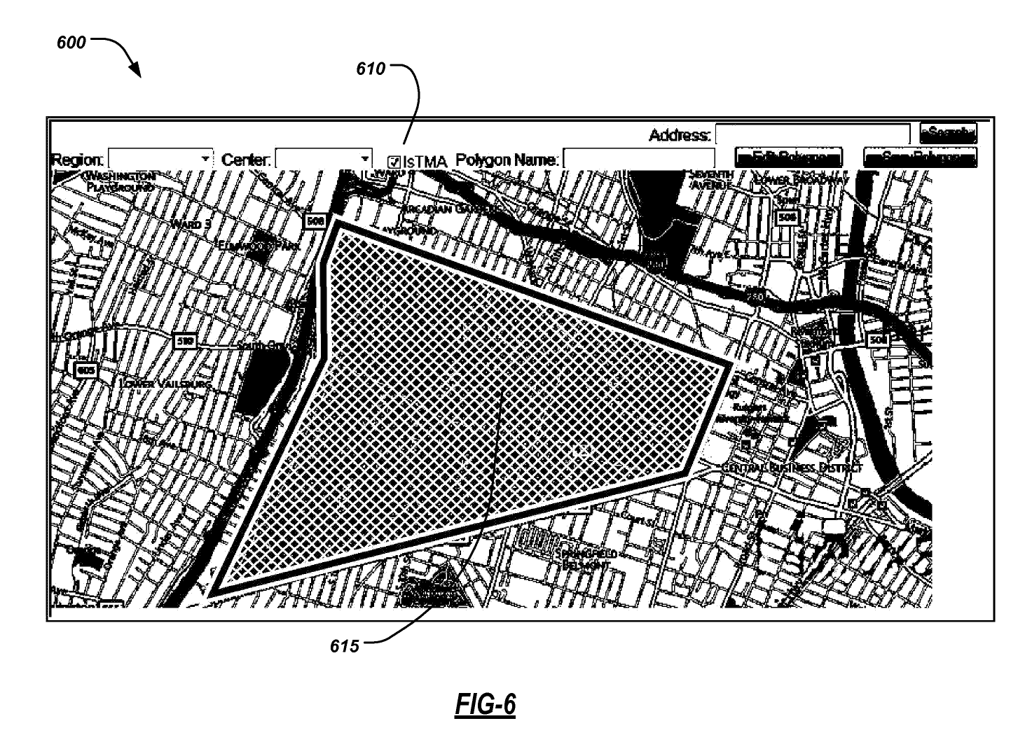

FIG. 6 is a screen shot of an exemplary “two person area” 615 (also known as a two-man-area or TMA) that requires that any field technician assigned to jobs in that geographic zone be a technician that knows how to work as part of a two-person team. The two-person-area indicator “IsTMA” 610 is checked. A two-person-area geographic zone 615 requires technicians with appropriate training for working as part of a two-person team in an area where personal safety or the security of equipment and vehicle may be a concern.

The two-person-area geographic zone 615 may have additional detail about when a two-person team is required in the two-person-area. For example, a time element may be involved related to when a two-person team is required (e.g., one person may work at a job location during the day, but two people are required after normal business hours or a two-person team may be needed only during certain days of the week, for example, only requiring a two-person team on the weekends).

An alternate way to specify a two-person-area may be to specify only one address or a range of addresses where there are safety or property concerns. Specifying a two-person-area with addresses may be more convenient and expeditious than interacting with a map for when a particular building is an area of risk. The exemplary dispatch system 100 may treat the address or range of addresses similar to a two-person-area geographic zone 615, like a two-person-area geographic zone 615, store the address or addresses as a two-person-area geographic zone 615, or may convert the address or addresses to a two-person-area geographic zone 615.

In addition, a geographic zone 310 may have multiple aspects associated to the geographic zone 310, for example, the geographic zone 315 may be both a two-person-area geographic zone 615 as well as a special axis zone 515.

Returning to FIG. 1, other alternative configurations are available as well, for example, the dispatching program 120 may not be located in the memory 115, but instead could be located on computer-readable medium and received by the processor 110 through the communication channels 140.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, a USB drive any other memory chip or cartridge, or any other medium from which a computer can read.

In general computing systems and/or devices, such as the hardware associated with the dispatch system 100 may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, a computer workstation, a server, a cloud computer, a desktop, notebook, laptop, or handheld computer, a cell phone, or some other computing system and/or device.

Computing devices generally include computer-executable instructions, where the instructions may be executable by one or more computing devices such as those listed above. Computer-executable instructions may be compiled or interpreted from computer programs, for example, created using a variety of programming languages and/or technologies, including, without limitation, and either alone or in combination, C, C++, C#, Java™, Visual Basic, Java Script, Perl, Python, PHP etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein. The communication channels 140 may be any available communication mechanism on a computing device, for example, a disk drive connector, a keyboard wire, a mouse wire, a USB, a network wired connection, a wireless connection, etc.

The memory 115 may hold a database 135 that contains jobs, technician profiles, geographic zones 310, dispatches, job assignment rules (e.g. garage-rules) etc. The database 135 may be part of the dispatch system 100 or alternatively the database 135 may be on a separate computing device, for example, a database system communicated with through the communications channels 140.

Databases, data repositories or other data stores described herein, may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned below and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language.

The dispatch system 100 may receive job requests from a number of sources, for example, a maintenance request or a customer call. The work dispatch center may gather jobs that need assigning. The job requests may be for various different tasks related to telecommunications, for example, installing a new plain old telephone (POTS) line, installing cable, removing a POTS line, etc. The job may be associated to a location, e.g., an address. The job may have an appointment time window during which the technician should do the work at the location.

The polygon subsystem 125 enables a user, such as a worker at a job dispatch center, to create geographic zones 310. The polygon subsystem 125 may allow the construction of an arbitrarily shaped geographic zone 310, for example, allowing the creation of an arbitrary polygon shape. The polygon subsystem 125 may use the geographic zone(s) 310 to classify incoming job requests based on the job location, e.g. address. The polygon subsystem 125 provides the ability to create, store, view, edit and delete geographic zones 310.

In one potential implementation, the geographic zones 310 are encoded as Global Position System, GPS, locations. The dispatch system may convert the job location into a job GPS location, and the dispatch system 100 may determine if the job location resides inside one of the geographic zone 310 based on the encoded GPS locations.

The dispatch system 100 gathers jobs that need to be assigned to technicians. The autoloader subsystem 130 may recommend the jobs to assign to technicians. The recommendation may be based first on preferred geographic zones 310 in the technician profiles. The autoloader subsystem 130 may also determine which technicians are capable of working in a geographic zone 310 based on additional requirements for the geographic zone 310 that a technician have additional non-technical attributes and the technician having those additional non-technical attributes, an example of a non-technical technician attribute being two-person team capable.

The autoloader subsystem 130 may support parallel assignment of work within both geographic zones 310 and DAAs 315. The autoloader subsystem 130 may show a dispatch-agent user a set of proposed jobs, both within a technician's preferred geographic zone 310 as well as other preferred DAAs 315.

The autoloader subsystem 130 may allow a user to assign technicians a primary geographic zone 310 and a secondary geographic zone 310. The autoloader subsystem 130 may first attempt to find a technician to work in their primary geographic zone 310 before attempting to find a field technicians that have the geographic zone 310 listed as a secondary geographic zone 310. If the autoloader subsystem 130 finds no jobs in any of the field technician's geographic zones 310, then the autoloader subsystem 130 may assign work to the field technician in other locations, for example, the preferred DAAs 315 (primary or secondary) listed in the technician profile.

The technician profile may have attributes, for example, capability of working in a two-person-area or authorized to work in a particular secured building. Field technician profiles contain information about various technicians that are available to work. A profile may contain information such as the technician's name, primary zone 310, secondary zone(s) 310, primary DAA(s) 315, secondary DAA(s) 315, the time of day their shift starts, the garage 210 they work out of, whether the technician works in two-person-areas. The dispatch system 100 may create a list of job items, the proposed daily dispatches, for the technician to work on.

The autoloader subsystem 130 may have a set of dispatch assignment rules that establish the requirements for the job assignments. The autoloader subsystem 130 may customize the rules at the garage 210 level. There may also be a series of steps (i.e. a schema) that the autoloader subsystem 130 may run that tries to develop a proposal of technician assignments using a series of steps. After each step, in the schema the autoloader subsystem 130 may run the garage-rules to ensure that all the current proposed job assignments meet the garage-rules and remove any assignments that failed to meet the garage-rules. In addition, the schema may configure the autoloader subsystem 130 to disable certain garage-rules after certain steps, although all the proposed assignments need to meet the garage-rules before the autoloader subsystem 130 finalizes the assignments.

An example of the steps in a schema may be a “same building” step where the autoloader subsystem 130 tries to assign jobs in the same building to the same technician. A schema step may be the “nearby building” step where the autoloader subsystem 130 tries to assign jobs in buildings that are within a short distance of each other (e.g. 2,000 to 3,000 feet) to the same technician. A schema step may be a “Same Hub same Tech” step where the autoloader subsystem 130 tries to assign jobs that receive a cable feed from the same cable hub to the same technician.

The autoloader subsystem 130 may have garage-rules specific to assigning jobs that are in geographic zones 310 and a garage administrator may turn on some of the zone list garage-rules on a particular day. The geographic zones 310 list garage-rules can be mutually exclusive, and only those garage-rules that are compatible with each other should be selected concurrently.

Technicians normally work out of a certain garage 210 but on occasion they are “loaned” to other garages 210. Technicians may be loaned from their normal garage 210 for various reasons, for example, when there are many repairs to be done after a storm, to help with installations for a special advertising promotion, at the start of the college semester, etc.

The autoloader subsystem 130 may have a zone list garage-rule “polygon work to polygon technicians,” in which case the autoloader subsystem 130 recommends assigning the jobs in geographic zones to technician profiles with matching preferred geographic zones. This rule may be used to ensure that geographic zone classified jobs are only assigned to profile's with preferred geographic zone preferences that match.

The autoloader subsystem 130 may have a zone list garage-rule “Ignore Loaned Techs” (that is used for technicians that are “on-loan” from their normal garage 210 to this garage 210), in which case the autoloader subsystem 130 ignores the technician's preferred geographic zones 310, where the preferred geographic zones 310 are either the primary or the secondary geographic zones 310. This rule may be used when the loaned technicians rarely are loaned to this garage 210 and may help ensure that the autoloader subsystem 130 ignores the preferred geographic zones 310, with the expectation that there are no preferred geographic zones 310 for the loaned technicians that are in this garage area 215.

The autoloader subsystem 130 may have a zone list garage-rule “Polygons to DAAs,” that ensures that a technician with both preferred geographic zones 310 and preferred DAAs 315 are first recommended all the geographic zone 310 jobs before recommending jobs based on their preferred DAAs 315. In an alternative implementation if a job location has both a preferred geographic zone 310 and a preferred DAA 315 that match a technician profile then, the technician profile may be given special priority for the job request.

The autoloader subsystem 130 may have a geographic zone list rule “Restrict Loaned Techs When Possible,” that insures that any jobs located in a loaned technician's primary geographic zone 310 are recommended first before jobs in other areas. This would be specified when there is a technician that is loaned to this garage 210 frequently enough that they are set up with preferred geographic zones 310.

The autoloader subsystem 130 may have a zone list garage-rule “Restrict to Primary Polygons,” that ensures technicians are only recommended jobs in their primary geographic zone 310.

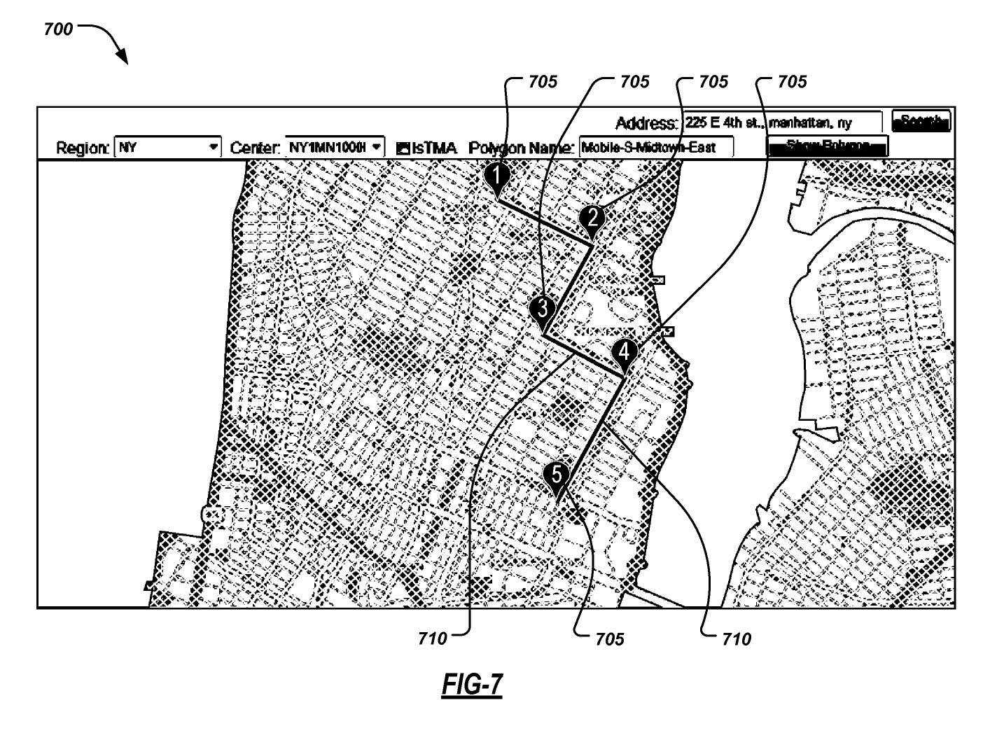

FIG. 7 shows a screenshot 700 that the polygon subsystem 125 may present to the user to construct a geographic zone 310.

The polygon subsystem 125 enables a user, for example, an administrator at a dispatch center, to create a geographic zone 310 by drawing a polygon of arbitrary size and shape using an interactive map to choose each polygon vertex 705 with mouse clicks within the map in a sequential manner, see vertices “1”, “2”, “3”, “4” and “5” 705. The polygon subsystem 125 creates connecting line segments 710 as each successive vertex 705 is chosen.

When the user has completed development of the polygon zone (not shown), i.e., when the last new vertex 705 has been chosen, the polygon subsystem 125 receives a “‘close’ the polygon” command and the final line segment 710 (not shown) is added that goes from the last vertex 705 to the first vertex 705 (i.e., “1”) to close the polygon zone.

When the polygon subsystem 125 receives the “Draw Polygon” command the polygon subsystem 125 provides the user with “Save” and “Cancel” functionality. Once the polygon subsystem 125 saves the geographic zone 310, then the geographic zone 310 can (1) flag incoming jobs that need dispatching and (2) be added to a field technician's profile as a primary or secondary geographic zone 310 that they may work in.

When the polygon subsystem 125 saves a new or edited geographic zone 310 the dispatch system 100 may retroactively reprocess all the jobs, that is the dispatch system 100 may reclassify the jobs into the newly created/edited geographic zone and make appropriate adjustments to the recommended assignments.

The polygon subsystem 125 may have the polygon be editable, allowing the editing of the polygon later, by presenting the polygon to the user with the ability to modify any polygon vertex and then save the modified geographic zone 310.

Although the geographic zone 310 has been described throughout this document as a polygon, there is no requirement that the geographic zone 310 be a polygon composed of vertices and line segments. Instead, the perimeter of the geographic zone 310 may be composed of other shapes such as arcs, tangents, polynomial equations, automatic geographic contours (like a river's edge) etc.

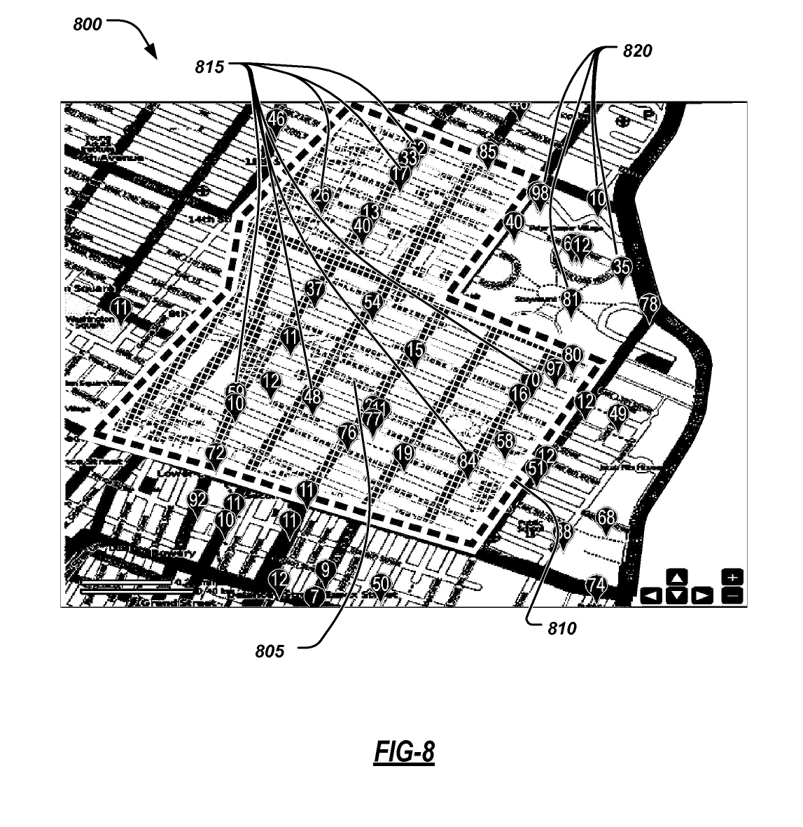

FIG. 8 shows a screenshot of the dispatch system 100 displaying a geographic zone 805 with jobs indicated by the markers. The autoloader subsystem 130 may provide the capability for a user, such as a dispatch-agent at a dispatch center, to view the jobs that are within a geographic zone 310, e.g. geographic zone 805 marked by border 810. This visibility provides the user with immediate knowledge of the jobs that are in a geographic zone 310 and eliminates the need to manually and laboriously determine, by job address, which jobs are within a geographic zone 310 and thus require the dispatch-agent to only assign those jobs to two-person team capable technicians. The graphical depiction of information provides a very quick graphical view of the information that allows a user of the dispatch system 100 to quickly ascertain if a job is part of the geographic zone 310 (e.g., zone 805) or not. For example, balloon markers indicate jobs, and some of the balloon markers 815 indicate jobs that reside inside the geographic zone 805, as compared to the other balloon markers, such as those indicated by balloon markers 820 that reside outside the geographic zone 805.

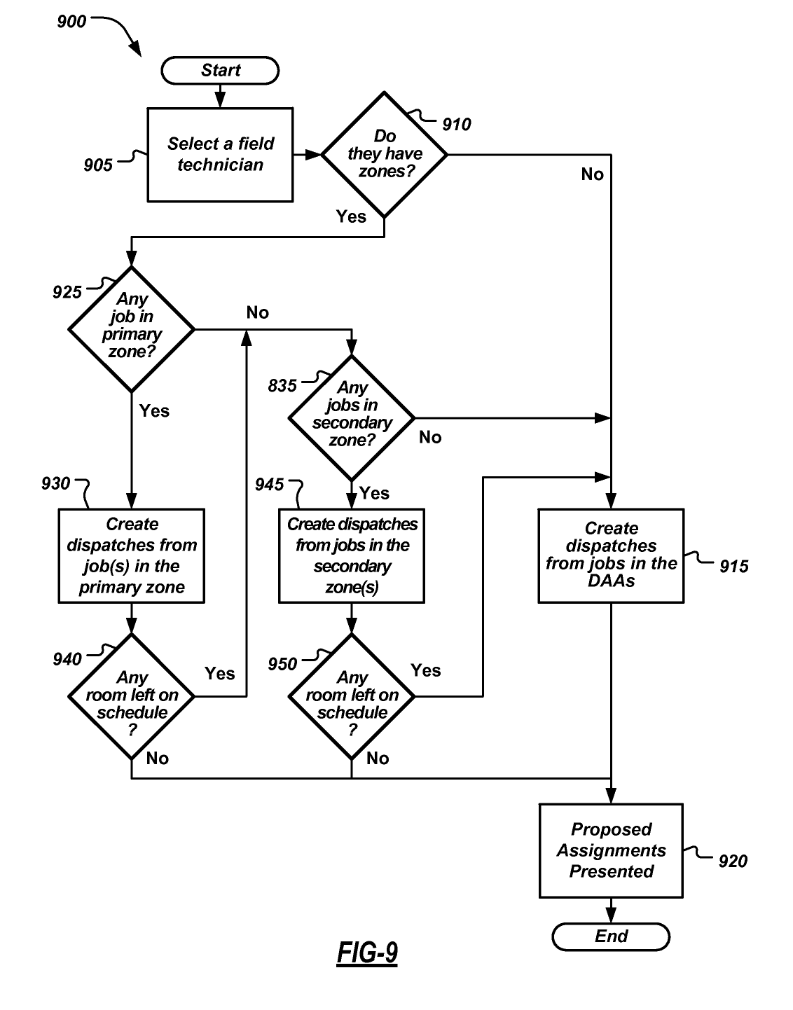

FIG. 9 is a flowchart of an exemplary process 900 that the autoloader subsystem 130 may use to assign dispatches to a technician to create a schedule of dispatches for the day.

At block 905, the autoloader subsystem 130 may select a technician profile for whom the autoloader subsystem 130 will create a dispatch schedule.

At decision diamond 910, the autoloader subsystem 130 may determine if the technician profile has any primary or secondary geographic zone specified. If the technician profile has either a primary or secondary geographic zone specified then the autoloader subsystem 130 may proceed to decision diamond 925. If the technician profile fails to have a primary or secondary geographic zone specified then the autoloader subsystem 130 may proceed to block 915.

At block 915, the autoloader subsystem 130 may assign jobs from the technician's primary or secondary DAA 315 so long as the jobs are not excluded based on being located in a geographic zone 310 that the technician profile is missing.

At decision diamond 925, the autoloader subsystem 130 may determine if there are any jobs in the technician's primary geographic zone 310. If there are jobs in the primary geographic zone 310 then autoloader subsystem 130 may proceed to block 930. If there fails to be any jobs in the primary geographic zone 310 then the autoloader subsystem 130 may proceed to decision diamond 935.

At block 930, the autoloader subsystem 130 may assign jobs from the primary geographic zone 310 to the technician dispatched schedule.

At decision diamond 940, the autoloader subsystem 130 may determine if there is any room left on the technicians dispatch schedule for more jobs. If there is more room on the technicians schedule then the autoloader subsystem 130 may proceed to decision diamond 935. If the technicians schedule is full then the autoloader subsystem 130 may proceed to block 920.

At decision diamond 935, the autoloader subsystem 130 may determine if there are any jobs in the technician's secondary geographic zone 310. If there fails to be any jobs and the secondary geographic zone 310 then the autoloader subsystem 130 may proceed to block 915. If there are jobs in the secondary geographic zone 310 then the autoloader subsystem 130 may proceed to block 945.

At block 945, the autoloader subsystem 130 may assign jobs 205 from the secondary geographic zone 310 to the technician dispatch schedule.

At decision diamond 950, the autoloader subsystem 130 may determine if there is any room left on the technicians dispatch schedule for more jobs. If there is more room on the technicians dispatch schedule then the autoloader subsystem 130 may proceed to block 915. If the technicians dispatch schedule is full then the autoloader subsystem 130 may proceed to block 920.

At block 920, the autoloader subsystem 130 may provide a proposed assignment schedule.

The geographic zones 310 may enable optimization by using special access geographic zones 515 to ensure that jobs assignments in special access areas are automatically assigned to field technicians that have the special access, e.g. they are authorized to enter the geographic zone 310, which save time. Logistical geographic zones 415 enable a dispatch system to minimize technician's transition time between jobs. The two-person-areas geographic zones 615 provides the advantage of automatically recognizing jobs that require a two-person team and may quickly suggest a two-person team that has proper training to work in a two-person-area. Further, the polygon subsystem 125 may allow editing of the geographic zone 310, which enables dispatch-agents, field technicians and others involved in dispatching process to adjust existing geographic zones 310 or create new geographic zones 310 to try and make the dispatching process more efficient.

Although the description involved users selecting points on a map, other means of determining the edge of a geographic zone 310 could be employed, for example, using street traffic flow analysis to determine optimal geographic zone 310 shape, demographic information, crime statistics etc.

Although primarily described in the context of a dispatch system, other systems may use the concepts as well. Any situation with a pre-existing geographic topography that needs certain areas prioritized independent of the pre-existing geographic areas could use the concepts presented herein. For example, for monitoring forest fires there could be an existing geographic grid used to investigate reports (e.g. reports of smoke, fire or suspicious behavior etc.). Based on fire risk conditions it may be desirable to designate certain areas as high-risk forest fire areas, for example, a drought area that poses a risk for a fire to spread quickly and uncontrollably. The system may define geographic zones 310 for these high-risk forest fire areas. The system may allow users to adjust the geographic zones 310 over time to reflect the current conditions. Any reports in the high-risk forest fire geographic zones 310 could receive prompt or special investigation.

Similarly, there could be an embodiment of the described system for surveys or petition signature gathering. Existing political/city areas and boundaries may provide a pre-existing topography used by survey takers and petition gatherers but certain geographic zones 310 might deserve special attention/priority. A geographic zone 310 could indicate areas having the best demographics in which residents are likely to favor and sign a petition. In addition, a geographic zone 310 could indicate a cultural or language area that require survey takers or petition gatherers with particular language or cultural skills.

There could be an embodiment of the described system for use by courts when a criminal or defendant is to remain within a certain area and avoid certain zones. For example when an individual is ordered to wear an ankle-tracking device and must stay inside a certain geographic area, e.g. within a city, county or state—perhaps while awaiting trial—but also may be required to avoid particular geographic zones 310, e.g. a restraining order to stay away from a certain persons house or work. In this system, there could be an area the individual is assigned to and then certain geographic zones 310 can be drawn indicating the areas that the restraining order specifies. Another example could be if a restraining order is for an individual to avoid going within five hundred feet of any elementary school. In this case, geographic zones 310 could be drawn to indicate the elementary school zones 310 that the individual needs to avoid.

There could be an embodiment of the described system for use by parents for tracking adolescence's use of a car. For example, a parent could specify to the system that the adolescence should only drive the car within the city but that the adolescent driver should avoid the downtown because the parent feels it is not safe. In this case, the system would enable the parent to specify the areas that the adolescent can drive the car (e.g. the city) but also specified the geographic zones 310 (e.g. downtown) that the adolescent driver should not enter. The system could even go so far as to notify the parent when the adolescent driver enters into the restricted geographic zone 310, or leaves the area.

An additional use for the geographic zone 310 is its use in on-demand dispatching. The dispatch system 100 may detect the technician completing their last assigned dispatch job, and at that point on-demand dispatching may provide a new dispatch to the technician that is in need of another dispatch job. The on-demand dispatch may search the available jobs that are close to the technician's current location. The on-demand dispatch may look to provide the technician with the closest job having the highest priority. The on-demand dispatch may still require the field technician match the requirements of a particular geographic zone 310, but they may ignore the primary and secondary DAA 315 in the field technician's profile, in favor of what is closer. For two-person-areas, the on-demand dispatch may still require not only that the field technician be capable of working on a two-person team but may also require the job's geographic zone 310 be on the technician's primary or secondary list in order to get a job that is in a two-person geographic zone 615.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

What is claimed as new and desired to be protected by Letters Patent of the United States is:

1. A system comprising:
a dispatch coverage region;
a set of non-overlapping dispatch assignment areas (DAAs) within the dispatch coverage region, wherein a DAA shape is based on at least a first aspect of the dispatch coverage region;
at least one non-overlapping geographic zone contained within the dispatch coverage region where a geographic zone shape is based on at least a second aspect of the dispatch coverage region that is different than the first aspect, and wherein the at least one geographic zone overlaps at least a portion of at least one DAA from the set of DAAs to define an overlapping area;
a set of technician profiles, where a first technician profile identifies a preferred geographic zone and a second technician profile identifies at least one preferred DAA; and
a job request that includes a location residing in the overlapping area; and
a computing device with a processor and memory configured to recommend the first technician profile for the job request when the preferred geographic zone matches the at least one geographic zone.

2. The system of claim 1, wherein the at least second aspect of the dispatch coverage region is from a list that includes 1) special access 2) two-person-area and 3) logistical continuity.

3. The system of claim 1, further comprising:
a second job request that includes a second location residing in the at least one DAA, but not in the at least one geographic zone and configured to recommend the second technician profile when the at least one preferred DAA matches the at least one DAA.

4. The system of claim 1, wherein the set of technician profiles further includes at least one technician with the preferred geographic zone includes a primary geographic zone and a secondary geographic zone, the system configured to recommend the at least one technician with a matching secondary geographic zone when no available technician has a matching primary geographic zone.

5. The system of claim 1, wherein the at least one geographic zone requires a non-technical technician attribute, and at least one technician profile includes a non-technical technician attribute, and wherein the recommended technician profile for the job request includes the required non-technical technician attribute.

6. The system of claim 5, wherein the required non-technical technician attribute is that the technician works in two-person-areas.

7. The system of claim 1, wherein the DAAs shapes are permanent.

8. The system of claim 7, wherein the shape of the at least one geographic zone is editable.

9. The system of claim 1, wherein the first aspect of the dispatch coverage region is wiring in the dispatch coverage region.

10. A computing device configured to execute a software application on a processor of the computer device to provide operations comprising:
having a dispatch coverage region;
covering the dispatch coverage region with a topography composed of a plurality of dispatch assignment areas (DAAs), where each location is contained in one and only one DAA and the topography is based on at least a first aspect of the geographic coverage region;
creating at least one geographic zone contained in the dispatch coverage region wherein a geographic zone shape is based on at least a second aspect of the dispatch coverage region that is unrelated to the first aspect and at least one geographic location in the dispatch coverage region is contained in the at least one geographic zone;
identifying a set of field technician profiles including at least one technician profile with a preferred geographic zone;
recommending assigning a job request to a technician profile, wherein the job request has a job location; and
when the job location is contained within an overlap of the at least one geographic zone and the DAAs, matching a technician profile to the job request based on finding a technician profile with a preferred geographic zone that matches the at least one geographic zone.

11. The computing device of claim 10, wherein the at least second aspect of the dispatch coverage region, used when creating the at least one geographic zone, is from a list including 1) a requirement for technicians to be authorized to access the geographic zone, 2) a two-person-area requirement, and 3) logistical continuity.

12. The computing device of claim 11, wherein when the second aspect is a two-person-area requirement then the at least one geographic zone requires a non-technical technician attribute, and wherein matching the technician to the job includes matching the required non-technical technician attribute with the technician profile that has a matching non-technical technician attribute.

13. The computing device of claim 12, wherein the required non-technical technician attribute is that the technician works in two-person-areas.

14. The computing device of claim 10, wherein:
identifying the set of field technician profiles with the preferred geographic zone including a primary geographic zone and a secondary geographic zone, and
recommending assigning the job to a technician with a matching secondary geographic zone attribute when the job location is contained within the at least one geographic zone and there is no available technician with a matching primary geographic zone attribute.

15. The computing device of claim 10, wherein:
identifying the set of field technician profiles including at least one technician with at least one preferred DAA, and
recommending assigning, when the job location is not contained within a geographic zone, the job request to a technician profile with a preferred DAA that matches a DAA that the job location is contained within.

16. The computing device of claim 10, wherein the first aspect of the dispatch coverage region is a physical wire distribution.

17. The computing device of claim 10, wherein the at least one geographic zone shape is editable.

18. A method comprising:
having a dispatch coverage region;
covering the dispatch coverage region with a topography composed of a plurality of dispatch assignment areas (DAAs), where each location is associated with one and only one DAA and the topography is based on at least a first aspect of the dispatch coverage region;
creating at least one geographic zone contained in the dispatch coverage region wherein a geographic zone shape is based on a second aspect of the dispatch coverage region that is unrelated to the first aspect and at least one geographic location in the dispatch coverage region is contained in the at least one geographic zone;
identifying a set of technician profiles including at least on technician profile with a preferred geographic zone;
recommending assigning a job request to a technician profile, wherein the job request has a job location; and
when the job location is contained within the at least one geographic zone, matching a technician profile to the job request based on matching a technician profile with the preferred geographic zone that matches the at least one geographic zone.

19. The method of claim 18, wherein creating at least one geographic zone requires a non-technical technician attribute, and wherein the recommended technician profile for the job request includes the required non-technical technician attribute.

20. The method of claim 19, wherein the required non-technical technician attribute is that the technician profile includes working in two-person-areas.

21. The method of claim 18, wherein:
identifying the set of field technician profiles with the preferred geographic zone including a primary geographic zone and a secondary geographic zone, and
recommending assigning the job to a technician with a matching secondary geographic zone when the job location is contained within the at least one geographic zone and there is no available technician with a matching primary geographic zone.

22. The method of claim 18, wherein:
identifying the set of field technician profiles including at least one technician with at least one preferred DAA, and
recommending assigning, when the job location is not contained within a geographic zone, the job request to a technician profile with a preferred DAA that matches a DAA that the job location is contained within.

23. The method of claim 18, wherein the at least one geographic zone shape is editable.
